(19) United States
(12) Patent Application Publication
(10) Pub. No.: US 2008/0075280 A1
(43) Pub. Date: Mar. 27, 2008

(54) GROUP-WISE SECRET KEY GENERATION

(75) Inventors: Chunxuan Ye, King of Prussia, PA (US); Alexander Reznik, Titusville, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/859,503

(22) Filed: Sep. 21, 2007

Related U.S. Application Data
(60) Provisional application No. 60/826,484, filed on Sep. 21, 2006.

(51) Int. Cl. H04L 9/28; H04K 1/00; H04L 9/30

(52) U.S. Cl. 380/44; 380/28

(57) ABSTRACT

The present invention relates to a method for constructing a perfectly secret key within a group of nodes. In a group of m nodes, pair-wise secret keys are assigned. Based on pair-wise secret keys, these m nodes generate a group-wise perfectly secret key. In a preferred embodiment, each node communicates with every other node through public noiseless broadcasts.

### CROSS REFERENCE TO RELATED APPLICATION

This application claims the benefit of U.S. provisional application No. 60/826,484 filed on Sep. 21, 2006, which is incorporated by reference as if fully set forth.

### FIELD OF INVENTION

The present invention generally relates to encryption of communications. More particularly a group-wise secret key generation algorithm method and mechanism is disclosed.

### BACKGROUND

In a symmetric encryption system, two nodes need to share a common secret key for secure communication between them. In most existing symmetric encryption systems, the secret key shared by the two nodes is computationally secure. Algorithms of generating a computationally secret key include Diffie-Hellman key exchange and public key-based (i.e., encrypting a secret key with the recipient's public key before its distribution).

The security of a computationally secret key relies on the difficulty in solving a computational problem, e.g., factoring large integers or computing discrete logarithms in certain groups. In other words, the security depends on the assumption that an eavesdropper's computational power is restricted. However, with advances in fast computing, this assumption may not hold. Therefore, a new method and apparatus, which is not susceptible to the weaknesses of computational cryptography, is needed.

On the other hand, if the security of a secret key can be rigorously established without any assumption of limits on an eavesdropper's computational power, then this secret key is called a perfectly secret key. A security system based on a secret key would not be subject to the weaknesses of non-secret key systems. The problem of generating a perfectly secret key has been investigated by several authors. To generate a perfectly secret key, access to a natural source of statistical randomness is needed. Currently, there are two preferred natural sources of statistical randomness. The first is quantum cryptography, which uses quantum mechanics to guarantee secure communication. Using quantum states such as quantum entanglement, a communication system can be designed and implemented which detects the amount of eavesdropping, and after correcting for this allows provably secure communication. The second method involves the use of wireless channels in conjunction with joint-randomness-not-shared-by-others (JRNSO) techniques, where each node shares a unique channel impulse response. It should be mentioned that these earlier works study the generation of a secret key between two nodes. In a communication system with more than two nodes, all the nodes or a subset of more than two nodes are required to share a common secret key for the secure group communication. While previous work has demonstrated in theory how to establish an optimum secret key with more then two nodes, it has not been successful in demonstrating practical algorithms for establishing an optimum secret key in communication systems with more than two nodes that perform optimally or close to optimally. Additionally, prior work in this field calls for a group key generation algorithm that works directly with the plurality of the underlying random sources. However, such an approach is complex and an approach which generates group keys based on the pre-generated pair-wise keys is desired (i.e., only the pair-wise key generation problem uses information about random sources). Such a layering would facilitate usage in existing layered communication systems. Therefore a practical implementation of an optimized method for generating a group-wise secret key in such systems is needed. Furthermore, it is desired that such an implementation have a layered structure.

Secret Key Capacity

The notion of secret key capacity is defined as follows. Suppose m≧2 network nodes respectively observe m independent and identically distributed repetitions, over n time intervals, of the random variables (X₁, X₂, . . . , Xₘ), denoted by (X₁⁽ⁿ⁾, X₂⁽ⁿ⁾, Xₘ⁽ⁿ⁾) with Xᵢ⁽ⁿ⁾=(X_{i,1}, . . . , X_{i,n}). These m nodes wish to generate a common (i.e., group-wise) secret key K. To do so, they can communicate with each other through an error-free public broadcast channel. A secret key rate H(K)/n is defined by the entropy rate of the secret key K. The largest secret key rate is called the secret key capacity, denoted by C_{S}. The notion of secret key capacity C_{S} indicates the length of the largest secret key that can be generated by these m nodes.

FIG. 1 shows a network of three nodes 101, 102 and 103, in which Key K_{1,2} exists between nodes 101 and 102, Key K_{1,3} exists between nodes 101 and 103, and Key K_{2,3} exists between nodes 102 and 103.

It is known in the art that the secret key capacity C_{S} can be calculated by the following equation:

$${C}_{S} = H ( {X}_{1} , … , {X}_{m} ) - {min}_{( {R}_{1} , … , {R}_{m} ) ∈ π} {\sum }_{i = 1}^{m} {R}_{i} , \qquad Equation ( 1 )$$

where

$$π = \{ ( {R}_{1} , … , {R}_{m} ) \text{:} {\sum }_{i ∈ β} {R}_{i} \geq H ( {X}_{β} \vert {X}_{{β}^{c}} ) , β ⋐ \{ 1 , … , m \} \} ,$$

with X_{β}={Xᵢ, iεβ} and β^{c}={1, . . . , m}\β.

For the case of two nodes (m=2), Equation (1) reduces to:
C_{S}=I(X₁;X₂) Equation (2)
where I represents the mutual information.
For the case of three nodes (m=3), Equation (1) reduces to:

$${C}_{S} = min \{ \begin{matrix}I ( {X}_{1} ; {X}_{2} ; {X}_{3} ) , \\ I ( {X}_{2} ; {X}_{1} ; {X}_{3} ) , \\ I ( {X}_{3} ; {X}_{1} ; {X}_{2} ) , \\ \frac{1}{2} [ H ( {X}_{1} ) + H ( {X}_{2} ) + H ( {X}_{3} ) - H ( {X}_{1} , {X}_{2} , {X}_{3} ) ]\end{matrix} \} . \qquad Equation ( 3 )$$

The translation of Equation (3) to the group-wise secret key problem described above is that the group-wise secret key cannot be longer than:

$$min \{ \begin{matrix}\vert {K}_{1 , 2} \vert + \vert {K}_{1 , 3} \vert , \\ \vert {K}_{1 , 2} \vert + \vert {K}_{2 , 3} \vert , \\ \vert {K}_{1 , 3} \vert + \vert {K}_{2 , 3} \vert , \\ \frac{1}{2} ( \vert {K}_{1 , 2} \vert + \vert {K}_{1 , 3} \vert + \vert {K}_{2 , 3} \vert )\end{matrix} \} . \qquad Equation ( 4 )$$

### SUMMARY

A method and mechanism is disclosed for constructing a perfectly secret key within a group of nodes. In a group of m nodes, pair-wise secret keys are assigned. Based on the pair-wise secret keys, these m nodes generate a group-wise perfectly secret key.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is an illustration of an exemplary communication network with three nodes and three pair-wise keys;

FIG. 2 is a method flow chart depicting the generation of a group-wise perfectly secret key;

FIG. 3 is an illustration of a weighted graph of a three node communication network;

FIG. 4 is an illustration of a weighted graph of the network of FIG. 2 after a first iteration of the group-wise secret key generation;

FIG. 5 is an illustration of a weighted graph of the network of FIG. 2 after a second iteration of the group-wise secret key generation;

FIG. 6 is an illustration of a weighted graph of the network of FIG. 2 after a third iteration of the group-wise secret key generation;

FIGS. 7 and 8 are method flow charts for implementing a group-wise secret key generation;

FIG. 9 is a block diagram showing three wireless transmit/receive units sharing a group-wise secret key;

FIG. 10 is a block diagram showing three nodes sharing a group-wise secret key over a fiber optic network;

FIG. 11 shows a network consisting of eight nodes;

FIG. 12 shows a spanning tree for the network of FIG. 11 used to generate a group-wise secret key.

### DETAILED DESCRIPTION OF THE PREFERRED EMBODIMENTS

When referred to hereafter, the terminology “wireless transmit/receive unit (WTRU)” includes, but is not limited to, a user equipment (UE), a network node, a mobile station, a fixed or mobile subscriber unit, a pager, a cellular telephone, a personal digital assistant (PDA), a computer, or any other type of user device capable of operating in a wireless environment. When referred to hereafter, the terminology “base station” includes, but is not limited to, a Node-B, a site controller, an access point (AP), or any other type of interfacing device capable of operating in a wireless environment.

In a first embodiment, an algorithm and mechanism for constructing a perfectly secret key within a group of nodes is disclosed. In a network of m nodes, it is assumed that every pair of WTRUs has already generated a perfectly secret key. An exemplary method for generating a perfectly secret key according to joint-randomness-not-shared-by-others is disclosed in commonly assigned U.S. patent application Ser. No. 11/339,958 filed on Jan. 26, 2006, which is incorporated herein by reference. A secret key shared by a pair of WTRUs is statistically independent of all other WTRU's knowledge. Based on pair-wise perfectly secret keys, these m WTRUs wish to generate a group-wise perfectly secret key. To do so, each WTRU can communicate with every other WTRU through public broadcasts. To avert miscommunication due to errors in the shared key, it is assumed that through appropriate channel protection codes can be applied such that the public broadcast would be received error-free. One such technique for error-free communication would include the use of Forward Error Correction (FEC). An eavesdropper, without any information on the pair-wise secret keys, is able to observe the public transmissions among the m WTRUs.

In an alternative embodiment, an algorithm and mechanism for constructing a perfectly secret key within a group of nodes connected by fiber optic links (FTRUs) is disclosed. In a network of m nodes, it is assumed that every pair of FTRUs has already generated a perfectly secret key using well-known quantum-cryptographic methods. A secret key shared by a pair of FTRUs is statistically independent of all other FTRU's knowledge. Based on pair-wise perfectly secret keys, these m FTRUs wish to generate a group-wise perfectly secret key. The nature in which they do so is identical to the nature in which WTRUs generate their group-wise shared keys.

The method, using either quantum cryptography or the wireless channel-based key generation, may be mathematically expressed as follows. Consider m nodes, where each pair of nodes share a perfectly secret key K_{i,j} (or equivalently K_{j,i}), with 1≦i≠j≦m. Then the mutual key I is represented as follows,
I(K_{i,j};{K_{i′,j′}:(i′, j′)≠(i, j)})≈0. Equation (5)

Without loss of generality, it is assumed that every pair-wise secret key K_{i,j} is a full entropy bit string, i.e.,
H(K_{i,j})≈|K_{i,j}|, Equation (6)
where |·| denotes the length of a bit string and H denotes entropy. Any well known high performance algorithm can be used to ensure the string is a full entropy bit string. Commonly implemented algorithms for full entropy include a Burrows-Wheeler Transform which is used in BZIP. Let V denote all the information contained in the public broadcast channel transmissions among the m WTRUs. After the transmissions, WTRU i calculates the group-wise secret key K according to the following constraints. The group-wise key is based on the WTRU's pair-wise secret keys {K_{i,j}:j≈i} and information V, such that:
I(K;V)≈0, and Equation (7)
H(K)≈|K|, Equation (8)
where Equation (7) denotes that the group-wise secret key is nearly statistically independent of eavesdropper's information, the information V on the public channel, and Equation (8) denotes that the group-wise secret key is a full entropy bit string. The condition implies that the group-wise secret key K is a perfectly secret key. A method and mechanism to maximize the length of the resulting group-wise secret key is therefore desired. The following describes a graphical representation of such a network to facilitate a first embodiment.

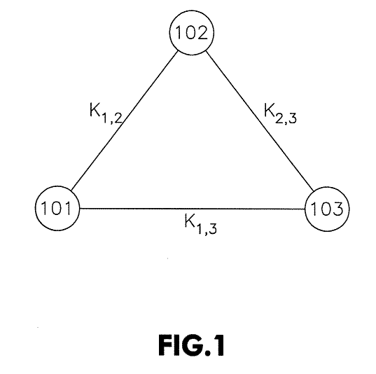

An undirected graph G=(N,E) with N nodes and E edges is said to be connected if, for every two distinct nodes i, jεN, there exists a path from node i to node j. Otherwise, the graph is said to be un-connected. Referring to FIG. 1, a connected graph with nodes 101, 102, and 103 is shown, with each pair of nodes sharing a pair-wise secret key K_{1,2}, K_{1,3}, K_{2,3}. A weighted graph associates a numerical weight with every edge in the graph. Referring back to FIG. 1, the weight of the edge is represented by their respective pair-wise secret keys, K_{1,2}, K_{1,3} K_{2,3}. Because the keys depicted are of only one bit, the respective edges all have a weight of one. The weight of a tree in a weighted graph is the sum of the weights of the selected edges.

A cut on a graph G=(N,E) is a partition of the nodes N into two sets N₁, N₂. Any edge (i, j)εE with iεN₁ and iεN₂ is said to be a cut edge. In weighted graphs, the size of a cut is defined to be the sum of the weights of its edges. A cut is minimal if the size of the cut is not larger than the size of any other cut.

Given a connected undirected graph G=(N,E), let E₁ be a subset of E such that a spanning tree is defined by T=(N,E₁). A minimum spanning tree from a weighted graph is defined such that the sum of the weights of its edges is as small as possible. The problem of finding a minimum spanning tree can be solved by an optimization algorithm, such as a greedy algorithm. In such a technique, a complex optimization problem is solved in an iterative manner by solving a simple local optimization problem at each step (i.e., by being greedy). In doing so, these algorithms typically deliver low computational complexity, while resulting in provably optimal or near optimal solution for many optimization problems. Two examples of greedy algorithms that can solve the minimum spanning tree problem are Kruskal's algorithm and Prim's algorithm.

Kruskal's algorithm is outlined by the following steps:
1. Sort the edges of G in increasing order by weight;
2. keep a subgraph T of G, initially empty;
3. for each edge e in sorted order, if the endpoints of e are disconnected in T, add e to T;
4. return T.

Prim's algorithm is outlined by the following steps:

1. Let T be a single node in G;

2. while (T has fewer nodes than G);

3. find the smallest weight edge connecting T to G-T;

4. add it to T;

5. return T.

The respective running times of the Kruskal algorithm and the Prim algorithm are represented by O(r+m log m) and O(m²), where m and r are the number of nodes and edges in G, respectively.

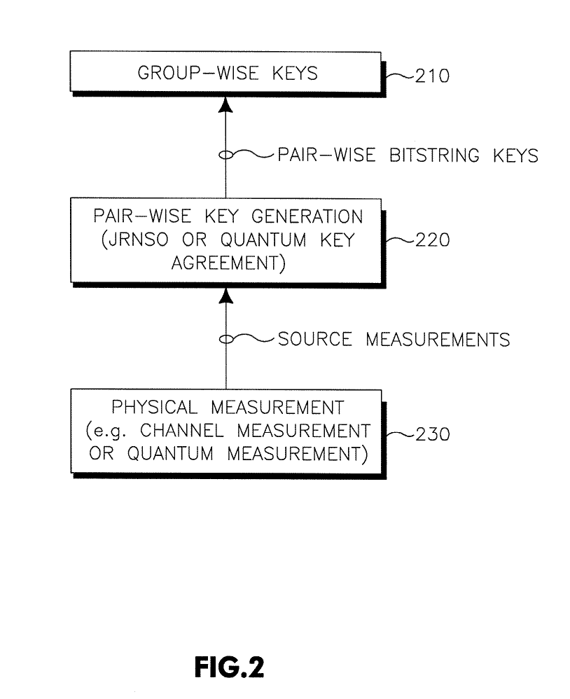

Referring to FIG. 2, a flow chart showing an example of how to solve the problem of generating a group-wise secret key. In the first step 230, a statistically random source is required for creating a pair-wise secret key. In FIG. 2, the source is derived through physical measurement, which can be accomplished by either channel measurement or quantum measurement. The source measurements are then used to generate a pair-wise perfectly secret key in step 220. Finally, in step 210 the pair-wise perfectly secret keys are used to generate a group-wise secret key for a system with more than 2 nodes.

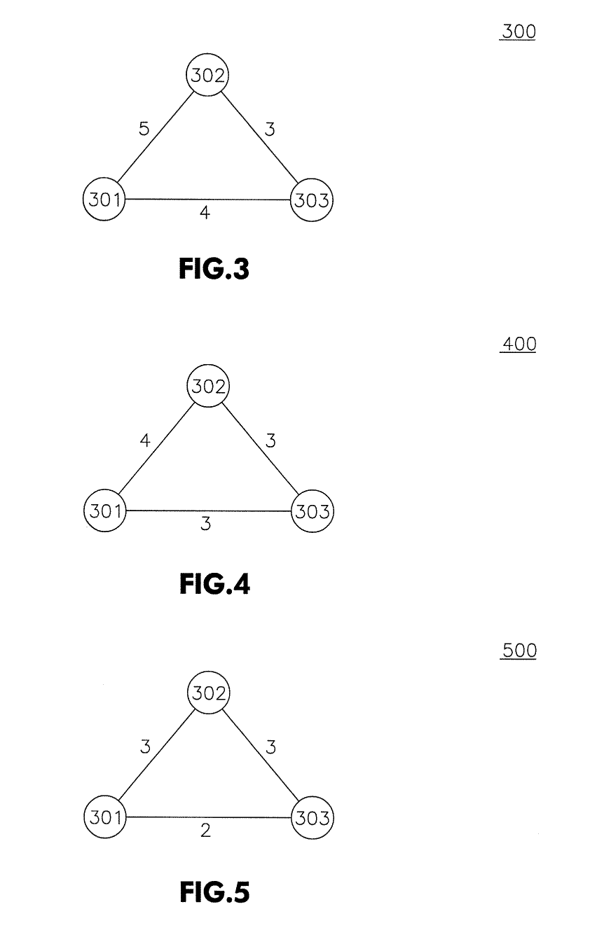

The group-wise secret key generation problem can be modeled by a weighted undirected graph. FIG. 3 shows a weighted graph for a three node network, having nodes 301, 302 and 303. Each node on the graph represents a network node or WTRU, and each pair-wise secret key is considered as an edge connecting the corresponding nodes. The weight of an edge is equal to the length of the corresponding pair-wise secret key, which is always a nonnegative integer. For example, referring to FIG. 3, suppose nodes 301, 302 and 303 share pair-wise secret keys K_{1,2}, K_{1,3} and K_{2,3} with lengths 5, 4 and 3, respectively.

The following lemma discusses the generation of a single secret bit among m nodes, based on a single bit from m−1 pair-wise secret keys whose corresponding edges constitute a spanning tree. Consider an arbitrary tree connecting m nodes. If every pair of neighbor nodes on the tree shares a single pair-wise secret bit, then a single secret bit can be generated among all m nodes. The following method presents a way of generating a secret bit among all m nodes.

Step 1: Select an edge (i₁, i₂) from the spanning tree. Nodes i₁ and i₂ share a secret bit Kᵢ_{₁}_{,i}_{₂}.

Step 2: If a node j knows secret bit Kᵢ_{₁}_{,i}_{₂} from either node i₁, or node i₂, sharing the key, but its neighbor node k does not know secret bit Kᵢ_{₁}_{,i}_{₂}, then node j sends K_{j,k}⊕Kᵢ_{₁}_{,i}_{₂} to node k, where K_{j,k} is the secret bit shared by nodes j and k. Upon receiving this message, node k is able to decode secret bit Kᵢ_{₁}_{,i}_{₂}. Repeat this step until the above condition does not hold.

The iteration is completed when all nodes are able to decode Kᵢ_{₁}_{,i}_{₂}. In other words, the secret bit Kᵢ_{₁}_{,i}_{₂} is securely transmitted along the spanning tree. Since the pair-wise secret keys satisfy Equations (5) and (6), secret bit Kᵢ_{₁}_{,i}_{₂} is independent of all the transmissions, i.e.,
I(Kᵢ_{₁}_{,i}_{₂};{Kᵢ_{₁}ᵢ_{₂}⊕K_{j,k}:(j,k)≈(i₁i₂})=0. Equation 9
Hence, Kᵢ_{₁}_{,i}_{₂} is the secret bit shared by all m nodes.

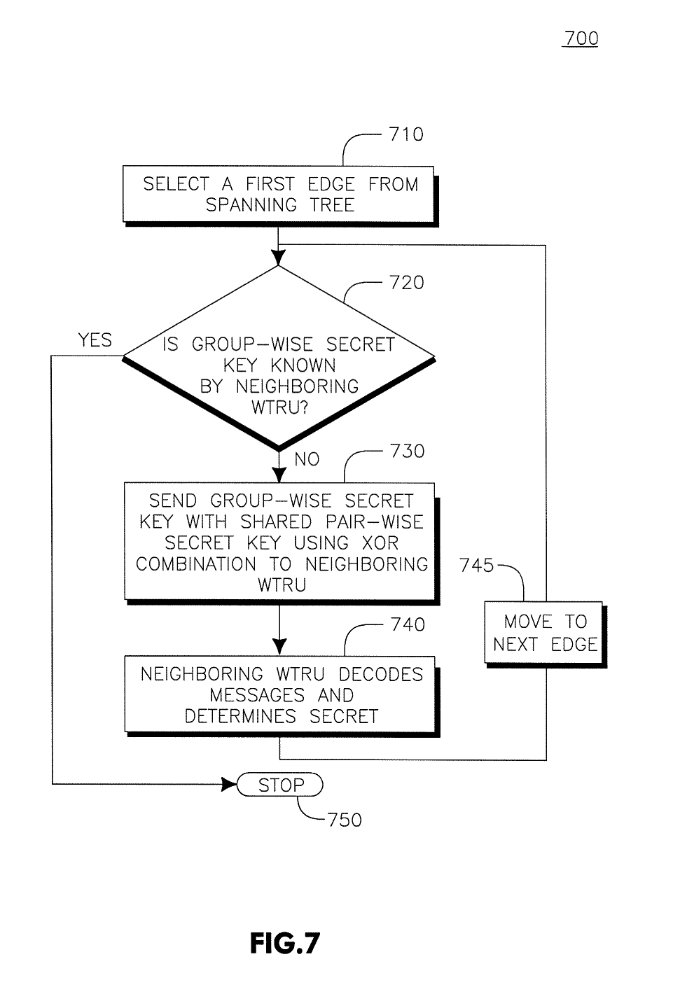

Referring to FIG. 7, a method 700 is shown which implements the above described method of sharing the secret bit. In step 710 a WTRU selects an edge from the spanning tree. This selection of an edge can be a random selection or by selecting the maximum or minimum edge weight. In the next step 720 the WTRU determines whether or not the secret key bit Kᵢ_{₁}_{,i}_{₂} is known by a neighboring WTRU. If Kᵢ_{₁}_{,i}_{₂} is not known, then the WTRU sends K_{j,k}⊕Kᵢ_{₁}_{,i}_{₂} (i.e. the XOR combination of the secret bit Kᵢ_{₁}_{,i}_{₂} and the pair wise key K_{j,k}) to the neighboring WTRU in step 730. The neighboring WTRU is now able to decode secret bit Kᵢ_{₁}_{,i}_{₂} in step 740. The next edge is selected (745), and the process is continued until the secret bit is shared by each of the WTRUs in succession. Alternatively, more than one secret bit can be selected and shared with each transmission using the XOR combination with pair-wise secret keys. For each secret key bit, a unique pair-wise secret key bit must be XOR combined with it.

For a case where a secret bit is shared using method 700, the following method steps are used for constructing an optimized group-wise secret key of multiple bits. Note that the problems of determining maximum and minimum spanning trees are equivalent. A maximum spanning tree can be determined by negating edge weights and solving the minimum spanning tree problem on the resulting graphs.

Step 3: Determine a maximum spanning tree from a given connected weighted graph, using a greedy algorithm (e.g. Kruskal's or Prim's).

Step 4: Generate a single secret bit among all nodes by applying the method 700 as described above. Note that the used bits in pair-wise secret keys, which have been revealed to the eavesdropper, will be of no use in the remaining group-wise secret key generation process.

Step 5: Update the graph by reducing the edge weight by 1 for the edges on the determined spanning tree. Remove an edge when its weight becomes zero.

Step 6: If the remaining graph is unconnected, then stop. Otherwise, return to Step 3.

Each iteration of steps 3-6 generates a single common secret bit. Thus, the overall secret key length is equal to the number of iterations that can be run until the graph becomes unconnected. The purpose of searching a maximum spanning tree (rather than picking up an arbitrary spanning tree) is to maximize the number of iterations in the algorithm, by means of “balancing” edge weights in the weight reduction procedure.

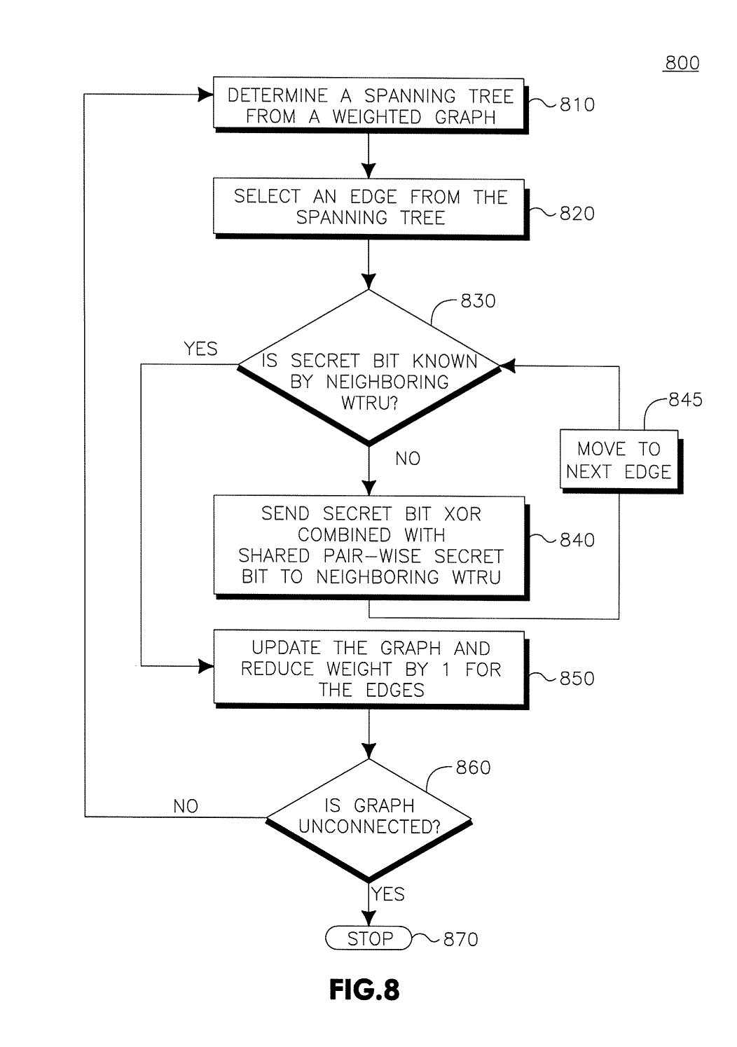

Referring to FIG. 8, a method 800 incorporating steps 3-6 above is shown. The first step 810 involves a lead WTRU determining a maximum spanning tree from the given weighted graph. Once the maximum spanning tree is determined, the WTRU uses the method 700 to generate a single common secret bit, described by steps 820-840. After an iteration, the graph must be updated by reducing the weight by 1 for the edges involved (step 850). Repeat the process until the graph is unconnected (step 860). The resulting group-wise secret key has a maximum possible length which will be shared by all of the WTRUs. The group-wise shared key allows the WTRUs to publicly broadcast messages which only the WTRUs within the network can decode. While the embodiment depicted by FIG. 8 shows the transmission of one secret bit during an iteration, multiple secret bits may be transmitted during an iteration as long as an equivalent number of pair-wise secret bits are XOR combined with the multiple secret bits.

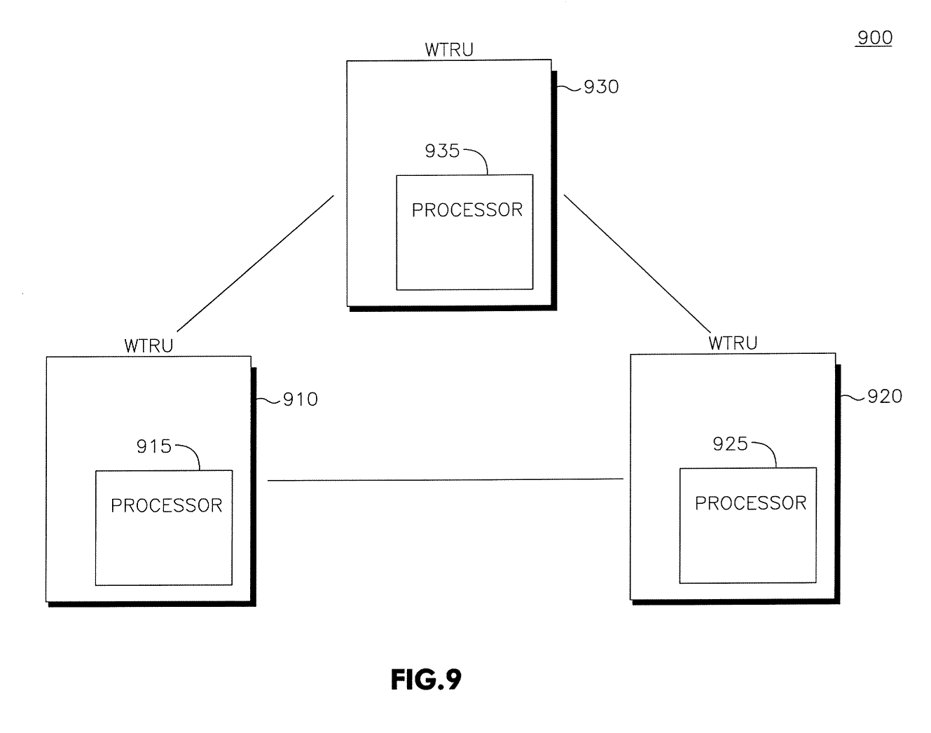

FIG. 9 shows block diagram of three WTRUs 910,920, and 930, forming a network over a wireless connection. A WTRU 910 acts as a lead node and initiates the procedures described above and determines the network topology. The lead node seeks to create a secret key with as many bits as possible. WTRU 910 comprises a processor 915 configured to implement methods 700 and 800 in order to generate a group-wise shared key. WTRU 910 then sends out messages informing the other WTRUs 920 and 930 regarding the selection of the key. The WTRUs 920 and 930 include processors 925 and 935 respectively, to process the key. It should be noted that while the depiction of this embodiment shows only three WTRUs, the process is applicable to an arbitrary number of WTRUs or nodes. Further, while FIG. 9 depicts a specific node acting as lead node, any node can make the decision. In another embodiment, the lead node makes the decision and transmits this decision along with the operations that each node should take, allowing the node to reduce the number of transmissions. In yet another embodiment, a wireless local area network hotspot or a base station can initiate the procedures described above.

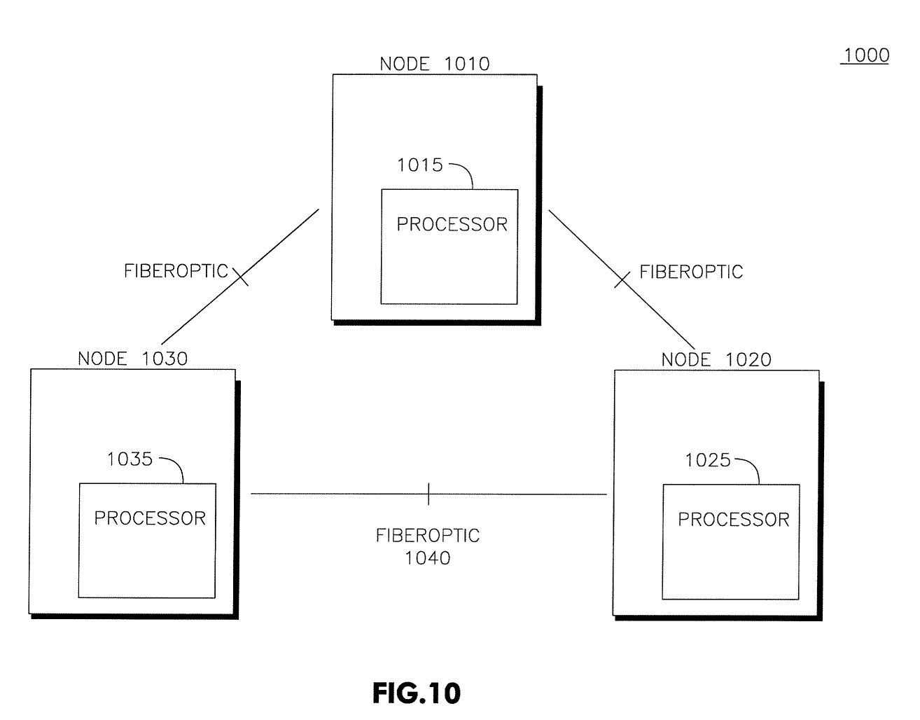

Referring to FIG. 10, an apparatus and network of another embodiment is shown. Each node generates a pair-wise secret key using quantum cryptography. The nodes are connected via a fiber-optic network 1040. A node 1010 acts as a lead node and initiates the procedures described above and determines the network topology. The lead node seeks to create a secret key with as many bits as possible. The processor 1015 of the lead node is configured to implement methods 700 and 800 in order to generate a group-wise shared key. The lead node then sends out messages over the fiber optic network, informing the other nodes 1020 and 1030 regarding the selection of the key. The nodes 1020 and 1030 include processors 1025 and 1035 respectively, to process the key. It should be noted that while the depiction of this embodiment shows only three nodes, the process is applicable to an arbitrary number of nodes connected over a fiber optic network.

Returning to FIG. 3, the process of generating a group-wise secret key using method 800 is now described. Let K_{1,2}=(K_{1,2}¹, . . . , K_{1,2}⁵), K_{1,3}=(K_{1,3}¹, . . . , K_{1,3}⁴), and K_{2,3}=(K_{2,3}¹, . . . , K_{2,3}³), where K_{i,j}^{k} denotes the k^{th} bit of the secret key shared by nodes i and j.

First Iteration:

A spanning tree composed of edges ((1,2), (1,3)) is selected in Step 1, because the sum of weights of this spanning tree is 9, which is larger than those of other spanning trees. Then node 301 sends K_{1,2}¹⊕K_{1,3}¹. Upon receiving the message, nodes 302 and 303 can decode K_{1,3}¹ and K_{1,2}¹, respectively. The bit K_{1,2}¹, (or K_{1,3}¹, but not both) is then set as the secret bit, as it is independent of K_{1,2}¹⊕K_{1,3}¹. By the end of this iteration, the weighted graph is adjusted, as shown in FIG. 4.

Second iteration:

A spanning tree composed of edges ((1,2), (1,3)) is determined in Step 1. Node 1 sends K_{1,2}¹⊕K_{1,3}², and the bit K_{1,2}² is set as the secret bit. By the end of this iteration, the weighted graph is adjusted, as shown in FIG. 5.

Third iteration:

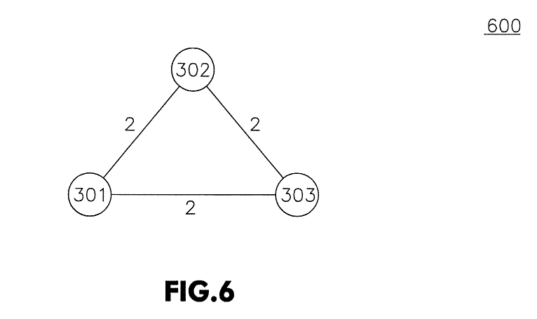

A spanning tree composed of edges ((1, 2), (2, 3)) is determined in Step 1. Node 2 sends K_{1,2}³⊕K_{1,3}¹, and the bit K_{1,2}³ is then set as the secret bit. By the end of this iteration, the weighted graph is adjusted, as shown in FIG. 6.

The iterations continue until the graph becomes un-connected. A total of six iterations are executed to un-connect the graph. The final three iterations are not depicted in the figures, however, the spanning trees and public transmissions in the last three iterations are

((1,2), (1,3)), ((1,2), (2,3)), ((1,3), (2,3)),

and

K_{1,2}⁴⊕K_{1,3}³, K_{1,2}⁵⊕K_{2,3}², K_{1,3}⁴⊕K_{2,3}³,

respectively. The secret key K is set as (K_{1,2}¹, K_{1,2}², K_{1,2}³, K_{1,2}⁴, K_{1,2}⁵, K_{1,3}⁴). As mentioned above, the largest achievable secret key in this example does not exceed 6 bits. Method 700 achieves this upper bound.

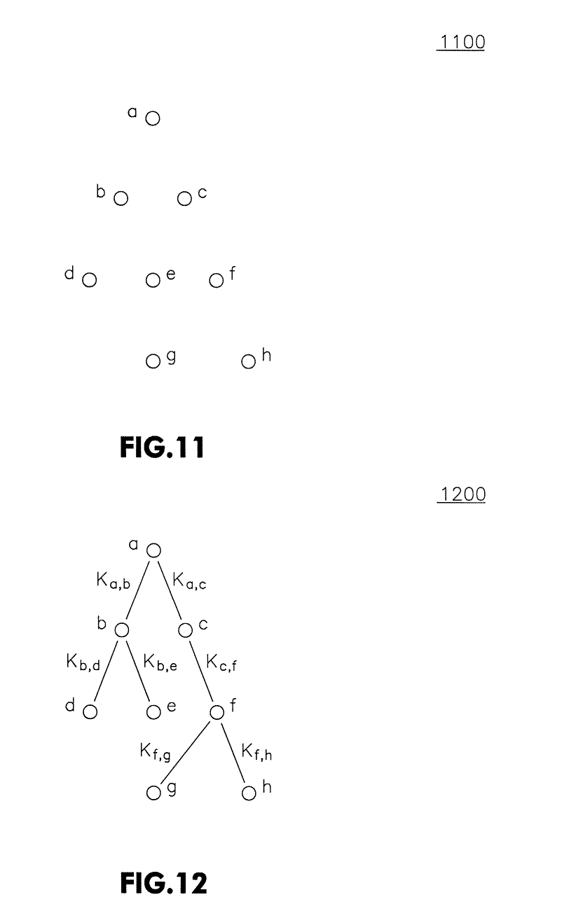

Referring to FIG. 11, consider a network with eight nodes, each node is represented by a terminal. Within the network, the terminals have acquired pair-wise perfectly secret keys. Each pair-wise perfectly secret key is statistically independent.

In FIG. 12, a spanning tree 1200 is selected from the network shown in FIG. 11. Each edge of the spanning tree represents a one bit pair-wise secret key (K_{a, b}, K_{a,c}, K_{b,d}, K_{b,e}, K_{c,f} . . . ). In order to create a group-wise perfectly secret key, Node a will select from key K_{a, b} or key K_{a, c} which will be chosen as the group-wise secret key. For purposes of this example, it is assumed that Node a has selected key K_{a, b}, however, in practice either bit could be selected randomly or through an algorithm. Node a will then transmit to Node b either K_{a,b}⊕K_{a,c} (which will equal 1) or transmit nothing. This will identify to Node b that K_{a, b} was chosen as the secret bit. Additionally Node a will transmit K_{a,b}⊕K_{a,c} to Node c, which Node C can decode using its pair-wise secret key K_{a, c}. Similarly, Node b and Node c then transmit key K_{a,b} to Node d, e, and f by convolving key K_{a,b} with the pair-wise secret key bits (K_{b,d}, K_{b,e}, K_{c,f} respectively) of each node. The process is continued until key K_{a, b} is known by the entire spanning tree, and a group-wise secret key K_{a, b}, will be known by all of the nodes. While the embodiment depicted in FIG. 11 shows only 8 nodes, the process is applicable for any number of nodes. Further, the embodiment in FIG. 12 depicts a secret key of only 1 bit, but a secret bit of any length may be used. In a variation to the embodiment, the nodes may transmit more than one secret bit to a neighboring node. Alternatively, the spanning tree is reselected after each iteration.

Although the features and elements are described in the preferred embodiments in particular combinations, each feature or element can be used alone without the other features and elements of the preferred embodiments or in various combinations with or without other features and elements. The methods or flow charts provided herein may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for generating a group-wise perfectly secret key in a wireless communication system having a plurality of wireless transmit/receive units (WTRU) utilizing symmetric key encryption, the method comprising:
a) generating a pair-wise perfectly secret key between at least two WTRUs; and
b) selecting a group-wise perfectly secret key K using the pair-wise secret keys.

2. The method as in claim 1, further comprising:
c) transmitting the group-wise perfectly secret key on a public broadcast channel to another WTRU using an XOR combination with a pair-wise perfectly secret key.

3. The method as in claim 1, further comprising:
c) determining a spanning tree from the plurality of WTRUs, the spanning tree having an edge weight between each WTRU pair equal to a length of a pair-wise perfectly secret key;
d) generating a group-wise perfectly secret key among m WTRUs according to a key from m−1 pair-wise secret keys; and
e) reducing an edge weight by a key length on the spanning tree.

4. The method as in claim 3, wherein the spanning tree is a maximum spanning tree.

5. The method as in claim 1, further comprising:
c) selecting an edge for a spanning tree having a corresponding pair-wise secret bit that is to be the group-wise perfectly secret key;
d) determining at a first WTRU that a neighboring WTRU lacks knowledge of the selected edge's secret bit;
e) transmitting the selected edge's secret bit from the first WTRU to a neighboring WTRU with the pair-wise secret key shared by the first WTRU and the neighboring WTRU using an XOR combination;
f) decoding the selected edge's secret key bit at the neighboring WTRU; and
g) repeating steps c) through f) until all WTRUs share the secret bit.

6. The method as in claim 5, further comprising:
h) determining a maximum spanning tree from the plurality of WTRUs, the maximum spanning tree having edge weights between each WTRU equal to the length of a pair-wise secret key;
i) reducing an edge weight by one bit on the maximum spanning tree following step e); and
j) removing an edge from the spanning tree when its edge weight becomes zero.

7. The method as in claim 6, wherein determining the maximum spanning tree is accomplished using a greedy algorithm.

8. The method as in claim 7, wherein the greedy algorithm is selected from the group consisting of a Kruskal algorithm and a Prim algorithm.

9. The method as in claim 3, wherein determining a maximum spanning tree includes selecting a WTRU such that the sum of all edges connecting to this WTRU is maximum.

10. The method as in claim 1, wherein the pair-wise perfectly secret key is generated based on joint randomness of the pair-wise channel.

11. The method as in claim 1, wherein the pair-wise perfectly secret key is generated based on a quantum entanglement.

12. A wireless transmit/receive unit (WTRU) capable of generating a group-wise perfectly secret key in a wireless communication system having a plurality of WTRUs utilizing symmetric key encryption, the WTRU comprising:
a processor configured to generate a pair-wise perfectly secret key with a connected WTRU;
a receiver for receiving a secret key on a public broadcast channel; and
a processor for determining a group-wise perfectly secret key K based on the pair-wise secret keys.

13. The WTRU as in claim 12, further comprising a transmitter for transmitting on a public broadcast the group-wise perfectly secret key channel that is XOR combined with the pair-wise perfectly secret key.

14. The WTRU as in claim 12, wherein the processor is configured to select a secret bit from an edge, further comprising a transmitter configured to transmit a selected edge's secret bit to a neighboring WTRU combined with the pair-wise secret key shared by the WTRU and the neighboring WTRU.

15. A method for generating a group-wise perfectly secret key in a fiber optic communication network having a plurality of nodes utilizing symmetric key encryption, the method comprising:
a) generating a pair-wise perfectly secret key between at least two nodes using quantum cryptography; and
b) selecting a group-wise perfectly secret key K using the pair-wise secret keys.

16. The method as in claim 15, further comprising:
c) transmitting the group-wise perfectly secret key on a public broadcast channel to another node using an XOR combination with a pair-wise perfectly secret key.

17. The method as in claim 15, further comprising:
c) determining a spanning tree from the plurality of nodes, the spanning tree having an edge weight between each node pair equal to a length of a pair-wise perfectly secret key;
d) generating a group-wise perfectly secret key among m nodes according to a key from m−1 pair-wise secret keys; and
e) reducing an edge weight by a key length on the spanning tree.

18. The method as in claim 17, wherein the spanning tree is a maximum spanning tree.

19. The method as in claim 15, further comprising:
c) selecting an edge for a spanning tree having a corresponding pair-wise secret bit that is to be the group-wise perfectly secret key;
d) determining at a first node that a neighboring node lacks knowledge of the selected edge's secret bit;
e) transmitting the selected edge's secret bit from the first node to a neighboring node with the pair-wise secret key shared by the first node and the neighboring node using an XOR combination;
f) decoding the selected edge's secret key bit at the neighboring node; and
g) repeating steps c) through f) until all nodes share the secret bit.

20. The method as in claim 15, further comprising:
h) determining a maximum spanning tree from the plurality of node, the maximum spanning tree having edge weights between each node equal to the length of a pair-wise secret key;
i) reducing an edge weight by one bit on the maximum spanning tree following step e); and
j) removing an edge from the spanning tree when its edge weight becomes zero.

21. The method as in claim 20, wherein determining the maximum spanning tree is accomplished using a greedy algorithm.

22. The method as in claim 21, wherein the greedy algorithm is selected from the group consisting of a Kruskal algorithm and a Prim algorithm.

23. The method as in claim 17, wherein determining a maximum spanning tree includes selecting a node such that the sum of all edges connecting to this node is maximum.
